(19) United States
(12) Patent Application Publication
(10) Pub. No.: US 2025/0165325 A1
(43) Pub. Date: May 22, 2025

(54) Embedded Device in a Vehicle

(71) Applicants: Inventec (Pudong) Technology Corp., Shanghai (CN); Inventec Corporation, Taipei (TW)

(72) Inventors: Chun-Shen Chen, Taipei (TW); Shu-Wei Hsu, Taipei (TW); Chia-Hang Chang, Taipei (TW)

(73) Assignees: Inventec (Pudong) Technology Corp., Shanghai (CN); Inventec Corporation, Taipei (TW)

(21) Appl. No.: 18/597,943

(22) Filed: Mar. 7, 2024

(30) Foreign Application Priority Data
Nov. 20, 2023 (CN) 202311549328.4

(51) Int. Cl. G06F 11/07; G06F 11/20; G06F 11/32

(52) U.S. Cl. CPC G06F 11/076; G06F 11/2023; G06F 11/325

(57) ABSTRACT

An embedded device in a vehicle includes a power switch, a first memory, a second memory, a platform controller hub, a switching unit, and a logic chip. The power switch is used to generate and output an enable signal when triggered. The first memory is used to store boot data. The second memory is used to store the boot data. The platform controller hub is coupled to the power switch, and selectively coupled to the first memory and the second memory. The switching unit is coupled to the first memory, the second memory and the platform controller hub. The logic chip is coupled to the platform controller hub and the switching unit for selectively generating and outputting a switching signal to the switching unit. When the switching unit receives the switching signal, the platform controller hub is coupled to the second memory.

### BACKGROUND OF THE INVENTION

### 1. Field of the Invention

The invention is related to an embedded device in a vehicle, particularly related to an embedded device in a vehicle with a backup memory.

### 2. Description of the Prior Art

Advanced driver assistance system (ADAS) is a control system that actively maintains overall safety functions. It uses various sensors such as radars and cameras installed on the vehicle to collect data on the surrounding environment of the vehicle, and performs static and dynamic objects recognition, detection and/or tracking. Combined with the navigation map data, systematic calculation and analysis are performed to make behavioral decisions, so that the driver can be aware of possible dangers in advance and directly control the vehicle to avoid collisions if necessary, which can effectively improve driving safety and comfort.

Generally, the software of the advanced driver assistance system (ADAS) is installed on a center computer or an embedded device of the vehicle. It needs to access the memory when the center computer or the embedded device is turned on. During the accessing process, memory accessing failure may occasionally occur, thus the advanced driving assistance system (ADAS) of the entire vehicle is not enabled, adversely affecting the user experience and driving safety.

### SUMMARY OF THE INVENTION

An embedded device in a vehicle comprises a power switch, a first memory, a second memory, a platform controller hub, a switching unit, and a logic chip. The power switch is configured to generate and output an enable signal when triggered. The first memory is configured to store boot data. The second memory is configured to store the boot data. The platform controller hub is coupled to the power switch, and selectively coupled to the first memory and the second memory, and configured to receive the enable signal, generate an access signal according to the enable signal, and output the access signal to the first memory. The switching unit is coupled to the first memory, the second memory and the platform controller hub. The logic chip is coupled to the platform controller hub and the switching unit, and configured to selectively generate and output a switching signal to the switching unit when the platform controller hub fails to access the boot data from the first memory, wherein when the switching unit receives the switching signal, the platform controller hub is coupled to the second memory.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of the embedded device in a vehicle according to an embodiment of the present invention.

FIG. 2 is a flow chart illustrating the memory switching method of the embedded device in FIG. 1.

FIG. 3 is a flow chart illustrating another memory switching method of the embedded device in FIG. 1.

### DETAILED DESCRIPTION

The detailed features and advantages of the present invention are described below in the embodiments. The content is sufficient to enable one skilled in the art to comprehend and implement the technical content of the present invention. According to the detailed description, claims and accompanying drawings, one skilled in the art can easily understand the relevant objects and advantages of the present invention. The following embodiments further elaborate the aspects of the present invention, but do not limit the scope of the present invention in any way.

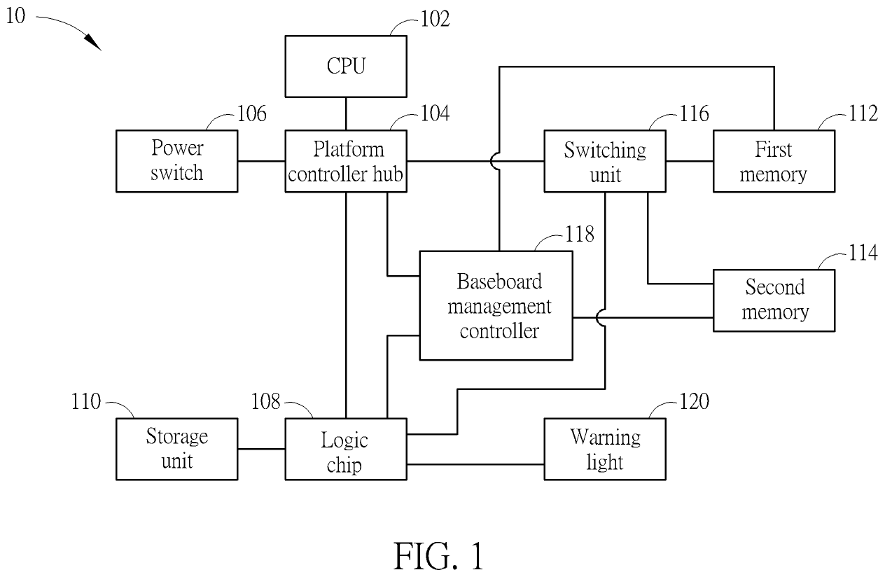

FIG. 1 is a block diagram of the embedded device 10 in a vehicle according to an embodiment of the present invention. As shown in FIG. 1, the embedded device 10 includes a central processing unit (CPU) 102, a platform controller hub (PCH) 104, a power switch 106, a logic chip 108, a storage unit 110, a first memory 112, a second memory 114, a switching unit 116, a baseboard management controller (BMC) 118 and a warning light 120. The embedded device 10 in the vehicle can be, for example, a center computer or a computing device of a vehicle, and can be used for navigation, driving recording, surrounding scene calculations, audio-video media playback, voice/video calls, wireless communications (connecting other vehicles or devices with WiFi/5G), collection of various vehicle status information, and safety protection calculations (such as running advanced driving assistance system algorithms), but are not limited thereto. The central processing unit (CPU) 102 is coupled to the platform controller hub 104 and executes the operating system in the embedded device and the above-mentioned functions. The power switch 106 generates and outputs an enable signal when triggered.

The first memory 112 stores boot data, and the second memory 114 also stores the boot data. The boot data stored in the first memory 112 and the second memory 114 are the same. The data content is the data required when the embedded device 10 on the vehicle is initialized. The function of the boot data is similar to the basic input/output system (BIOS) in the computer architecture. The second memory 114 can be regarded as a backup for the first memory 112. The first memory 112 and the second memory 114 can be flash memories, which can be updated with updated boot information.

The platform controller hub (PCH) 104 is coupled to the power switch 106, and selectively coupled to the first memory 112 or the second memory 114, and configured to receive the enable signal from the power switch 106. The platform controller hub (PCH) 104 generates an access signal according to the enable signal and outputs the access signal to the first memory 112. That is, in the normal configuration of the embedded device 10, the first memory 112 is the main memory and is coupled to the platform controller hub (PCH) 104.

The logic chip 108 is coupled to the platform controller hub (PCH) 104 and the switching unit 116, and configured to selectively generate and output a switching signal to the switching unit 116 when the platform controller hub (PCH) 104 fails to access the boot data from the first memory 112. When the switching unit 116 receives the switching signal, the platform controller hub (PCH) 104 is coupled to the second memory 114.

In an embodiment of the present invention, the failure of the platform controller hub (PCH) 104 to access the boot data from the first memory 112 is determined when the number of times the platform controller hub 104 fails to access the boot data from the first memory 114 is greater than a predetermined number. The storage unit 110 is coupled to the logic chip 108 for storing the number of times the platform controller hub 104 fails to access the boot data from the first memory 114. The predetermined number may also be stored in the storage unit 110 or the logic chip 108 but is not limited thereto. Moreover, the storage unit 110 may be an electronically erasable programmable read-only memory (EEPROM).

In an embodiment of the present invention, the failure of the platform controller hub (PCH) 104 to access the boot data from the first memory 112 is determined when a time duration for the platform controller hub 104 to access the boot data from the first memory 112 is greater than a predetermined time length. When the time duration is greater than the predetermined time length, the logic chip 108 generates and outputs a switching signal to the switching unit 116 so that the platform controller hub (PCH) 104 is coupled to the second memory 114.

In an embodiment of the present invention, the warning light 120 is coupled to the logic chip 108. When the logic chip 108 generates and outputs the switching signal to the switching unit 116, it also generates and outputs a warning signal to the warning light 120. The position of the warning light 120 may be displayed on the dashboard of the vehicle or on the display of the embedded device 10 to advise the user that the first memory 112 is damaged and needs to be updated or replaced.

The baseboard management controller (BMC) 118 is coupled to the platform controller hub (PCH) 104, the logic chip 108, the first memory 112 and the second memory 114. The baseboard management controller (BMC) 118 may have an external interface (such as a wired network interface or a connection to a wireless device). When the vehicle service station or user updates the firmware, the new boot data can be written into the first memory 112 and the second memory 114 through the baseboard management controller (BMC) 118. If the vehicle user cannot return to the service station to update the firmware, the vehicle user can download new boot data through the network device, and then write the new boot data to the first memory 112 and/or the second memory 112 through the baseboard management controller (BMC) 118. The purpose of writing the new boot data only to the first memory 112 is to prevent failure of booting the embedded device 10 normally if writing the new boot data fails. If this occurs, at least the second memory 114 is available for booting the embedded device 10 normally.

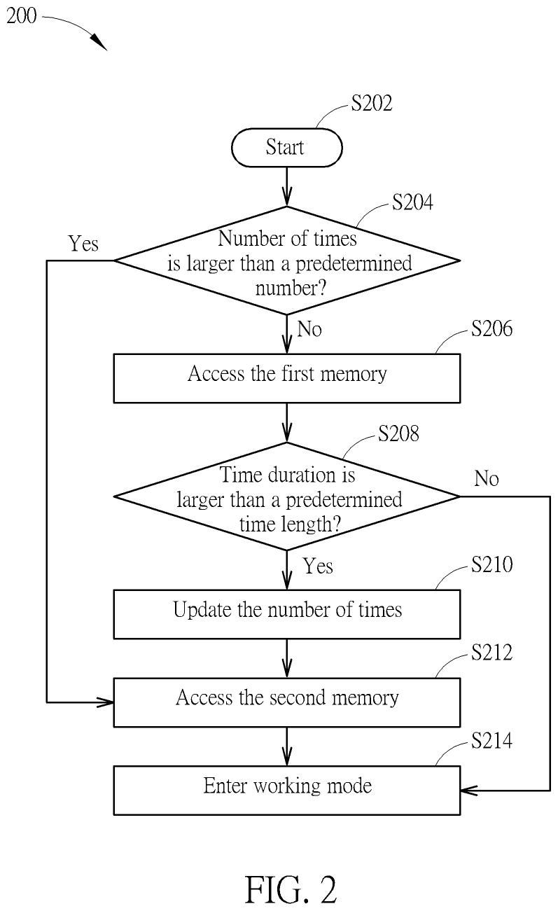

FIG. 2 is a flow chart illustrating the memory switching method 200 of the embedded device 10. In step S202, the vehicle may be designed such that when the vehicle is started, the platform controller hub (PCH) 104 and the baseboard management controller (BMC) 118 are enabled, and the embedded device 10 can be started by triggering the power switch 106 to prepare for the execution of the boot process. In another embodiment, when the vehicle is started, the embedded device 10 is also started to prepare for the execution of the boot process. In either embodiment, the power switch 106 will generate and output an enable signal to the platform controller hub (PCH) 104.

In step S204, the platform controller hub (PCH) 104 receives the enable signal from the power switch 106 and generates an access signal according to the enable signal. At this time, the logic chip 108 synchronously reads the number of times the platform controller hub 104 fails to access the boot data from the first memory 114 in the storage unit 110. Then, the number of times the platform controller hub 104 fails to access the boot data from the first memory 114 is compared with the predetermined number. When the number of times is greater than the predetermined number, the logic chip 108 generates and outputs a switching signal to the switching unit 116. Then, the platform controller hub (PCH) 104 outputs the access signal to the second memory 114 (step S212). On the contrary, in step S206, when the number of times is less than the predetermined number, the platform controller hub (PCH) 104 outputs the access signal to the first memory 112. The predetermined number may be 20, but is not limited thereto.

In an embodiment of the present invention, the platform controller hub (PCH) 104 may receive an enable signal from the power switch 106, generate an access signal according to the enable signal, and output the access signal to the first memory 112. At this time, the logic chip 108 learns whether the platform controller hub (PCH) 104 has accessed the boot data of the first memory 112 according to the voltage of one of the pins (for example, a general purpose input/output (GPIO) pin) on the platform controller hub (PCH) 104. When the logic chip 108 determines that the platform controller hub (PCH) 104 has not accessed the boot data of the first memory 112, the logic chip 108 stores the number of times the platform controller hub 104 fails to access the boot data from the first memory 114 in the storage unit 110. Then, the number of times is compared with the predetermined number. When the number of times is greater than the predetermined number, the logic chip 108 generates and outputs a switching signal to the switching unit 116. On the contrary, in step S206, when the number of times is less than the predetermined number, the platform controller hub (PCH) 104 outputs the access signal to the first memory 112.

In step S208, the logic chip 108 learns whether the time duration of the platform controller hub (PCH) 104 to access the first memory 112 is greater than a predetermined time length according to the voltage of one of the pins (for example, a GPIO pin) on the platform controller hub (PCH) 104. If the time duration is greater than the predetermined time length, the platform controller hub (PCH) 104 is determined to have failed accessing the first memory 112. On the contrary, when the time duration is less than the predetermined time length, the platform controller hub (PCH) 104 is determined to have successfully accessed the first memory 112. The embedded device 10 completes the booting process according to the boot data, starts the operating system (OS), and enters the working mode (step S214).

In step S210, the logic chip 108 increments the number of times the platform controller hub 104 fails to access the boot data from the first memory 114 in the storage unit 110 by one and updates the number of times in the storage unit 110. Next, in step S212, the logic chip 108 generates and outputs the switching signal to the switching unit 116. Then, the platform controller hub (PCH) 104 outputs the access signal to the second memory 114. Next, in step S214, the embedded device 10 completes the boot process according to the boot data, starts the operating system (OS), and enters the working mode.

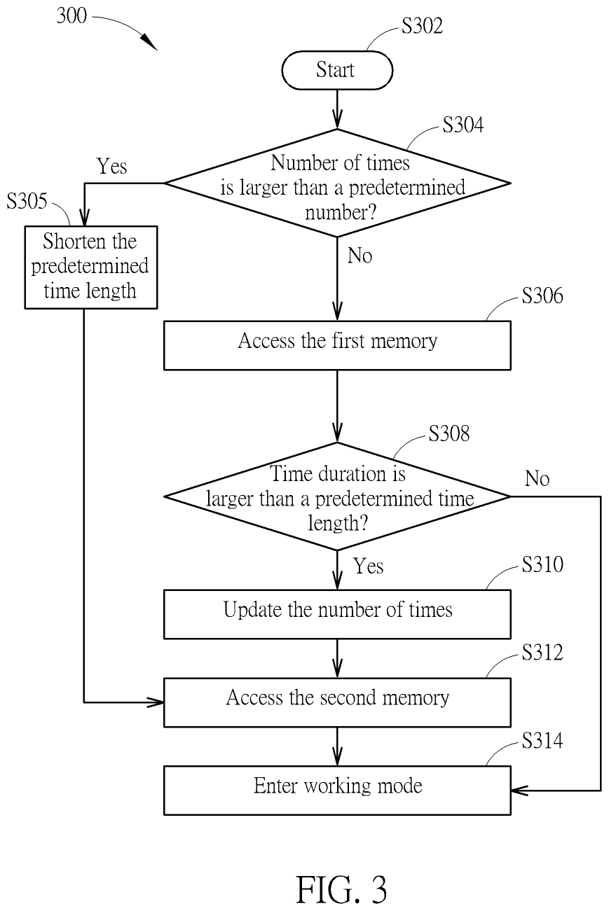

FIG. 3 is a flow chart illustrating another memory switching method 300 of the embedded device 10. In an embodiment of the present invention, the difference between FIG. 3 and FIG. 2 is that in step S304, when the logic chip 108 determines that the number of times the platform controller hub 104 fails to access the boot data from the first memory 114 is greater than the predetermined number, the predetermined time length is shortened in step S305. The logic chip 108 outputs the switching signal to the switching unit 116 as soon as possible. In the embodiment, when the vehicle is returned to the service station for maintenance, the technician can determine whether the first memory 112 needs to be replaced by reading the number of times the platform controller hub 104 fails to access the boot data from the first memory 114 in the storage unit 110 in the storage unit 110. In this embodiment, the embedded device of the present invention can be applied to vehicles, such as self-driving cars, electric cars, semi-autonomous cars, etc.

In conclusion, the present invention provides an embedded device 10 that can access the second memory 114 when the first memory 112 cannot be accessed to achieve the effect of damage rescue, and can also record the number of times the platform controller hub 104 fails to access the boot data from the first memory 114 in the storage unit 110 to allow the technician to determine the effectiveness of the first memory 112 of the embedded device 10, thus improving the safety of the vehicle.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An embedded device in a vehicle, comprising:
a power switch configured to generate and output an enable signal when triggered;
a first memory configured to store boot data;
a second memory configured to store the boot data;
a platform controller hub coupled to the power switch, and selectively coupled to the first memory and the second memory, and configured to receive the enable signal, generate an access signal according to the enable signal, and output the access signal to the first memory;
a switching unit coupled to the first memory, the second memory and the platform controller hub; and
a logic chip coupled to the platform controller hub and the switching unit, and configured to selectively generate and output a switching signal to the switching unit when the platform controller hub fails to access the boot data from the first memory;
wherein when the switching unit receives the switching signal, the platform controller hub is coupled to the second memory.

2. The embedded device of claim 1, wherein the platform controller hub is determined to have failed to access the boot data from the first memory when number of times the platform controller hub fails to access the boot data from the first memory is greater than a predetermined number.

3. The embedded device of claim 2, further comprising a storage unit coupled to the logic chip for storing the number of times the platform controller hub fails to access the boot data from the first memory.

4. The embedded device of claim 3, wherein when the platform controller hub fails to access the boot data from the first memory, the logic chip reads the number of times, and generates and outputs the switching signal to the switching unit when the number of times is greater than the predetermined number.

5. The embedded device of claim 1, wherein the platform controller hub is determined to have failed to access the boot data from the first memory when a time duration for the platform controller hub to access the boot data from the first memory is greater than a predetermined time length.

6. The embedded device of claim 5, wherein the logic chip generates and outputs the switching signal to the switching unit when the time duration is greater than a predetermined time length.

7. The embedded device of claim 5, further comprising a storage unit coupled to the logic chip, and configured to store number of times the platform controller hub has failed to access the boot data from the first memory.

8. The embedded device of claim 7, wherein when the logic chip determines that the time duration is greater than the predetermined time length, the logic chip increments the number of times the platform controller hub has failed to access the boot data from the first memory.

9. The embedded device of claim 1 further comprising a warning light coupled to the logic chip;
wherein when the logic chip generates and outputs the switching signal to the switching unit, the logic chip generates and outputs a warning signal to the warning light.
